(19) United States
(12) Patent Application Publication
(10) Pub. No.: US 2002/0124411 A1
(43) Pub. Date: Sep. 12, 2002

(54) Heavy duty artistic knife combined with a lamp

(76) Inventor: Yin-Hai Huang, Feng-Yuan (TW)

Correspondence Address: Yin-Hai Huang, P.O. Box 697, Feng-Yuan City, 420, TW

(21) Appl. No.: 09/802,058

(22) Filed: Mar. 6, 2001

(51) Int. Cl. B26B 1/08

(52) U.S. Cl. 30/161; 30/125

(57) ABSTRACT

A heavy duty artistic knife combined with a lamp including a housing combined with a first and second halves hinged together at their corresponding rear ends and locked up at their medial portion by a lock, the first half has a blade chamber for receiving spare blades, a battery chamber for receiving a pair of batteries and plurality of conductible plates which connect between the batteries and a pair lead-in wires from a lamp inside the front end of the housing. The lamp is operated by a blade assembly which is slidably moved as a switch to emit or to turn out the lamp. Except metallic material, the housing con be made of any rigid materials.

### BACKGROUND OF THE INVENTION

The present invention relates to artistic knife and more particularly to a heavy duty artistic knife combined with a lamp therein which can be made of non-metallic material and readily assembled or disassembled without any tools.

Nowadays, many tools such as a screwdriver or a wench had combined with lamp which provide much convenience to the user. Few of the artistic knife is combined with a lamp except one which recently appears in the market (as shown in FIG. 12). This artistic knife includes a battery chamber 51 containing a pair of mercury batteries or of lithium batteries 53 and 54. The battery 53 is anode side toward outside and the battery 54 is cathode toward outside. An lead-in wire 55 of the lamp 52 connects to the battery 53 and another lead-in wire 56 of the lamp 52 contacts to the metallic housing of the knife 50. A conduct plate 57 disposes between batteries 53 and 54. Another conduct plate 58 disposes to the under side of the battery 54 and has an elastic end 59 which enables to contact with the metallic housing of the knife. So that when the black rack slides forward to permit the elastic end 59 contacting the housing 50, a current circulation is therefore formed to light the lamp 52. If the blade rack slides back to its original position, the lamp 52 is put out due to that the elastic end 59 is disconnected the housing 50. Because the housing of this artistic knife could not made of other material such as the plastic or the appropriate material, it is not ideal. Further the metallic housing 50 conducts the electric current should have a large resistance that wastes the electricity.

### SUMMARY OF THE PRESENT INVENTION

The present invention has a main object to provide a heavy duty artistic knife combined with a lamp which the housing or handle can be made of a variety of materials except the conductible metallic material. Besides, the knife is readily to assemble and/or to disassemble.

Another object of the present invention is to provide a heavy duty artistic knife combined with a lamp in which the battery is readily to lead and/or to replace.

Further object of the present invention is to provide a heavy duty artistic knife combined with a lamp in which the conductive plates are stable and reliable and expend low electricity.

Further object of the present invention is to provide a heavy duty artistic knife combined with a lamp which can be opened without any tool, low breakdown and durable.

The present invention will become more fully understood by reference to the following detailed description thereof when read in conjunction with the attached drawings.

### BRIEF DESCRIPTION OF THE DRAWINGS

FIG. 1 is an exploded perspective view to show a heavy duty artistic knife combined with lamp according to the preferred embodiment of the present invention,

FIG. 2 is an exploded perspective view to show the battery chamber, the lamp and the relevant elements of the preferred embodiment of the present invention,

FIG. 3 is a perspective view to show the assembly of the present invention,

FIG. 4 is a side view to show the operation of a blade rack,

FIG. 5 is a side view of the enlarged battery chamber, the lamp and the relevant elements,

FIG. 6 is a sectional view of the present invention indicating that the cathode plate disengaged with the conductible plate where the blade rack is in its original position,

FIG. 7 is a sectional view of the present invention indicating that the cathode plate engaged with the conductible plate where the blade rack is slid forward,

FIG. 8 is a top view to show the hinge of the first half with the second half of the housing at their rear ends,

FIG. 9 is a top view the second half opening for about 90 degrees relative to the first half of the housing,

FIG. 10 is a side view to show the latch remaining at horizontal position where the two halves are unlocked,

FIG. 11 is a side view to show the latch turned to a vertical position where the two halves are locked together, and

FIG. 12 is a side view to show an artistic knife according to a prior art.

### DETAILED DESCRIPTION OF THE PREFERRED EMBODIMENT

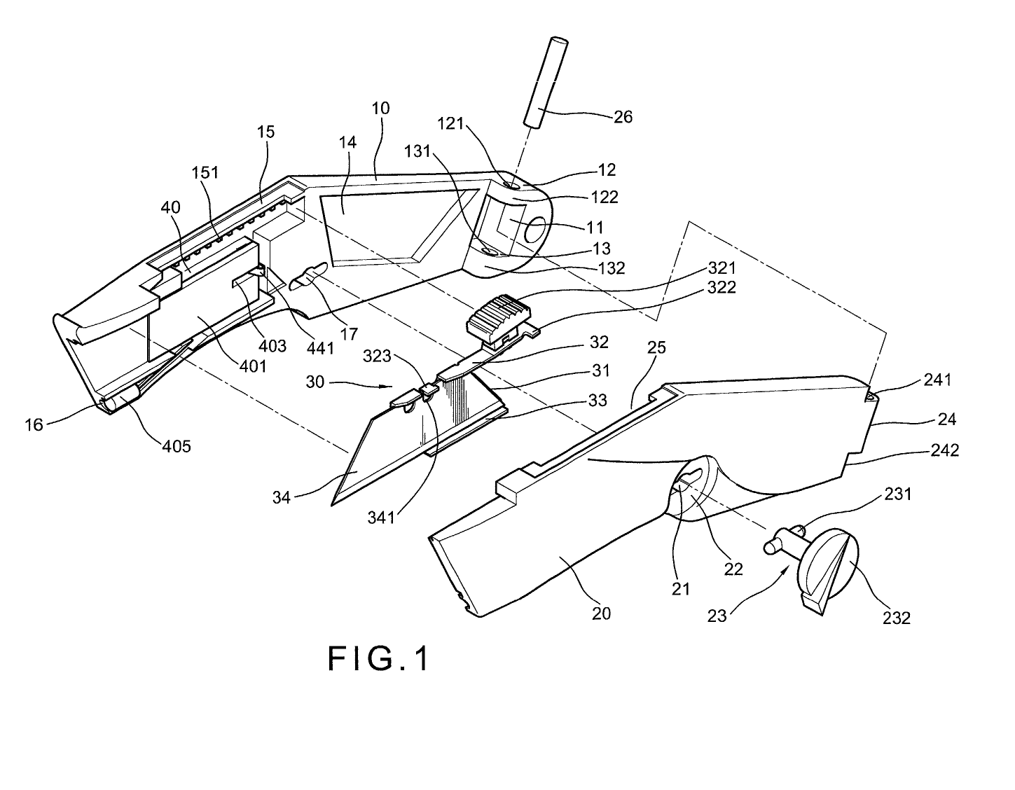

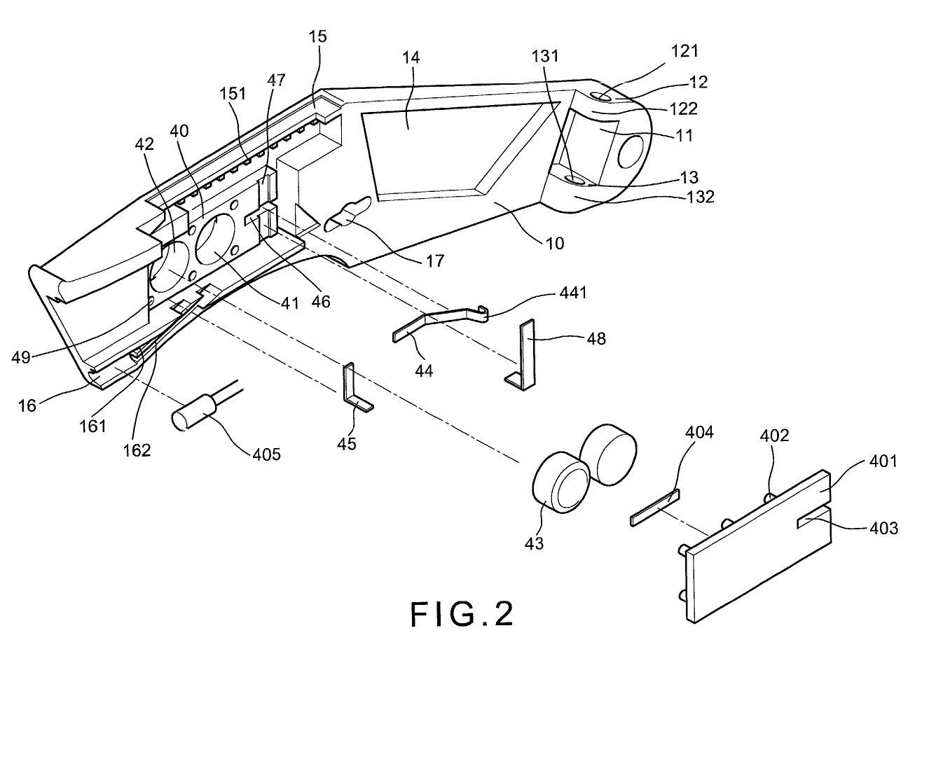

With reference to FIGS. 1 and 2 of the drawings, the heavy duty artistic knife combined with a lamp of the present invention comprises generally a housing or handle which is combined with a first half 10 and a second half 20, a blade assembly 30 and a battery chamber 40.

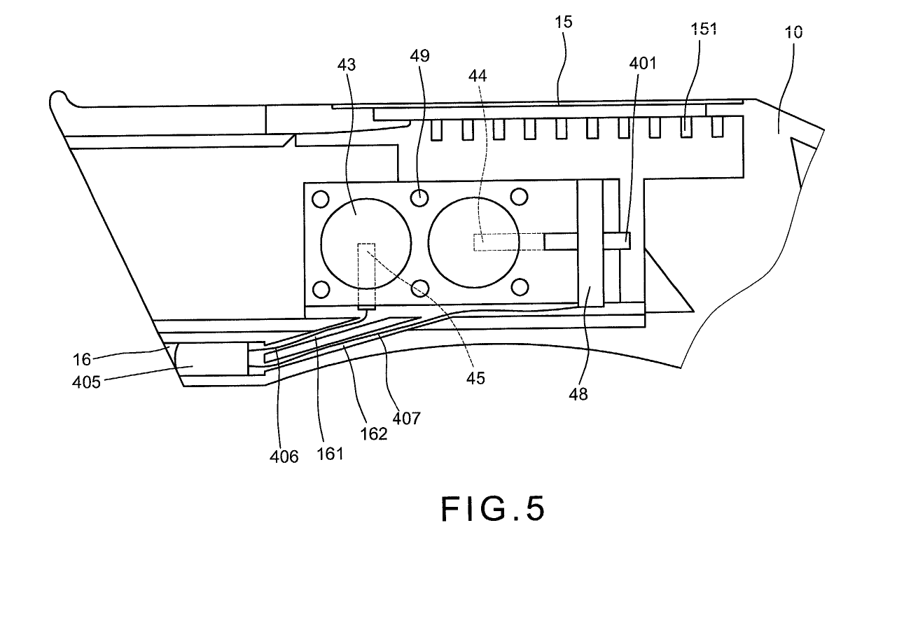

The first half 10 has a lug 11 at a rear end including an upper ear 12, a lower ear 13, each of the ears 12 and 13 having an axial hole 121 and 131 and round surface 122 and 132, a blade chamber 14 in an inner side adjacent the lug 11 for receiving space blades, a first rectangular groove 15 in the top adjacent the blade chamber 14, the rectangular groove having a plurality of positioning projections spacedly projected downward from the under side thereof, a battery chamber 40 in an inner wall under the rectangular groove 15, the battery chamber 40 having a pair of circular grooves 41 and 42 for receiving a pair of circular batteries 43 which may be the mercury battery or the lithium battery, one of the batteries 43 inside the groove 41 being cathode toward outside and the other inside the groove 42 being anode toward outside, the battery chamber further having a horizontal slot 46 for receiving a bent conductible plat 44 which has one end disposed on the bottom of the circular groove 41 and the other end a raising elastic plate 441, a vertical groove 47 crossified with the horizontal slot 46 for receiving a L-shaped conductible plate 48 engageable with the bent conductible plate 441, a plurality of retaining holes 49 spacedly formed in the inner wall for coupling with the plurality of protrudent rods 402 of a rectangular lid 401, the lid having a transverse slot in one end for permitting the rating elastic plate 441 passing through to expose to outside of the battery chamber 40, a rectangular conductible plate 404 disposed on the inner side of the lid 401 and respectively contacting the two batteries 43, a circular chamber 16 in a lower portion of the front end of the first half communicating to a pair of elongate grooves 161 and 162 for receiving a lamp 405 and pair of lead-in wires 406 and 407 (as shown in FIG. 5), the wire 406 connected to a V-shaped conductible anode plate 45 which has one end embedded in the bottom of the circular groove 42, the wire 407 connected to the L-shaped conductible cathode plate 48. The first half 10 further has a first horizontal locking hole 17 between the blade chamber 14 and the battery chamber 40.

The second half 20 has a second horizontal locking hole 21 engageable with the first horizontal locking hole 17, a circular groove 22, a lock 23 which is composed of a latch 231 and a swivel button 232, a barrel 24 projected outward from the rear end having an axial thru hole 241 and flat surfaces 242 aside the barrel 24 and a second rectangular groove 25 in a top engageable with the first rectangular groove 15 of the first half 10.

A blade assembly 30 mounts on a blade rack 31 which has an extension 32, a lower flange 33, a thumbpiece 321, a projection 322 under the thumbpiece 321 and a small plate 323. A blade 34 disposed into the rack 31 having a slot 341 engaged with the small plate 323. Wherein the projection 322 is engageable with the positioning projections 151 of the first half 10. So that the blade assembly can slide about the elongate grooves 15 and 25 and be retained in any adjacent positioning projections 151.

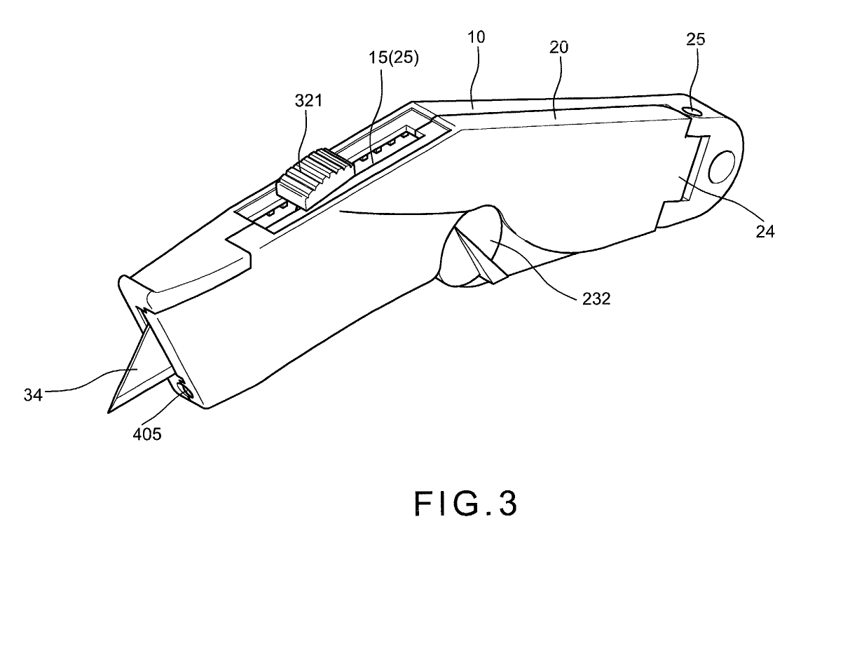

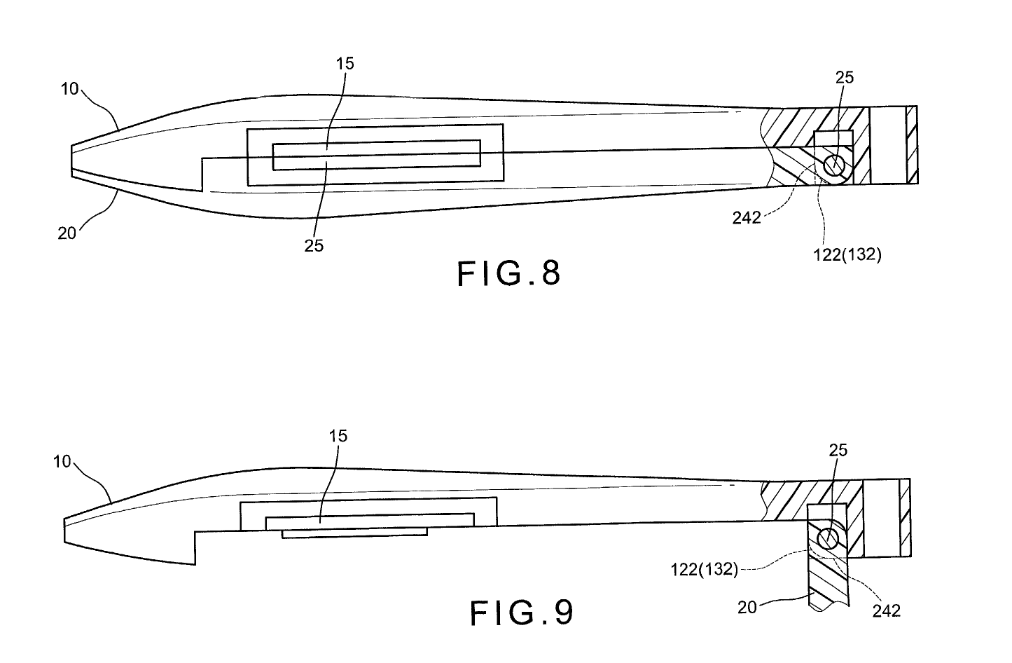

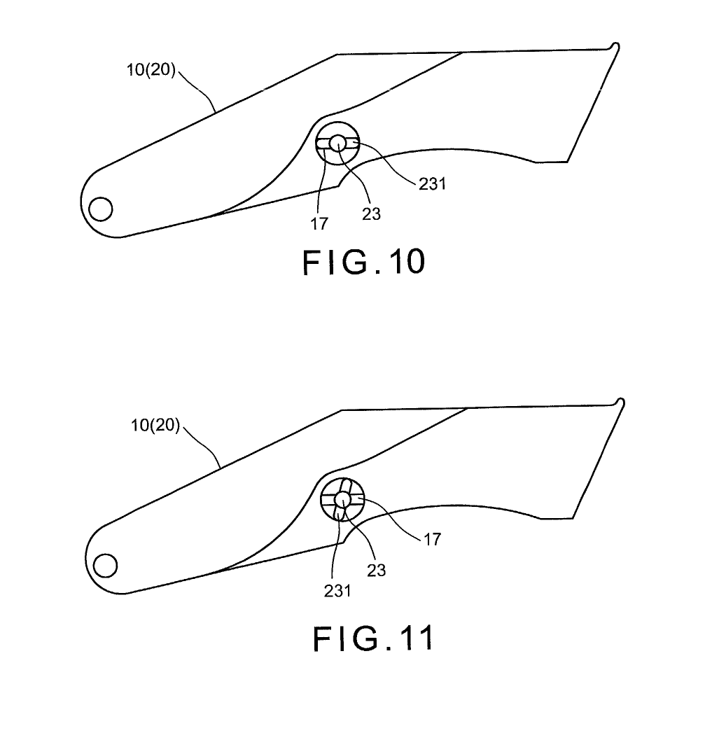

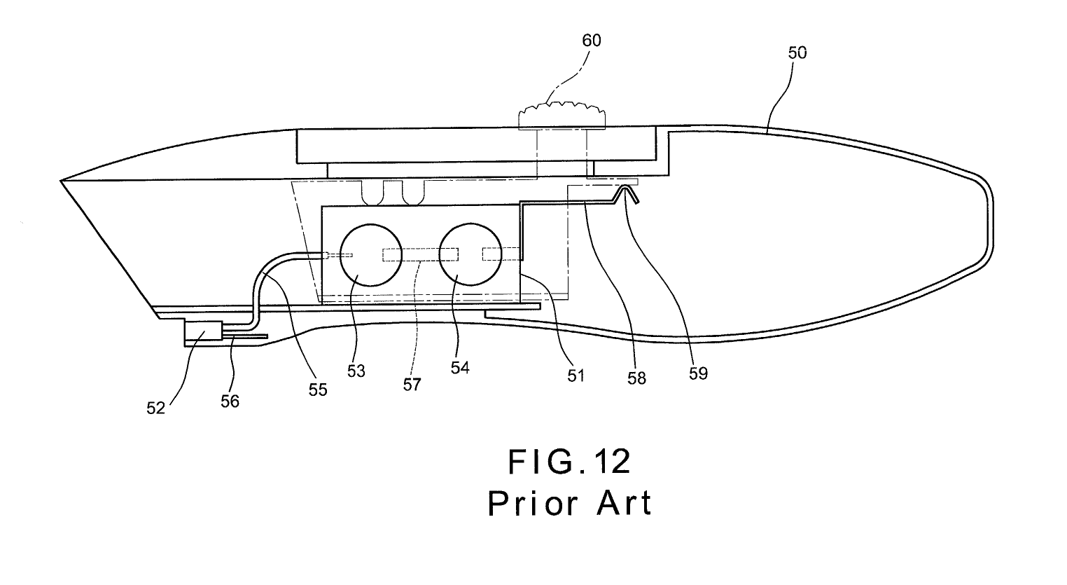

When assembly, first engage the barrel 24 of the second half 20 into the lug 11 of the first half 10 and retained by an axial pin 26 through the axial holes 121, 241 and 131 so that the two halves 10 and 20 are hinged together. Due to the Flat surfaces 242, the second half 20 can be opened for about 90 degrees relative to the first half 10 (as shown FIG. 9). Then engage the lock 23 into the horizontal slots 17 and 21 of the two halves 10 and 21 and turn the swivel button 232 for about 90 degrees so that the two halves 10 and 20 are eventually combined together (as show in FIGS. 1, 3, 8, 9, 10 and 11).

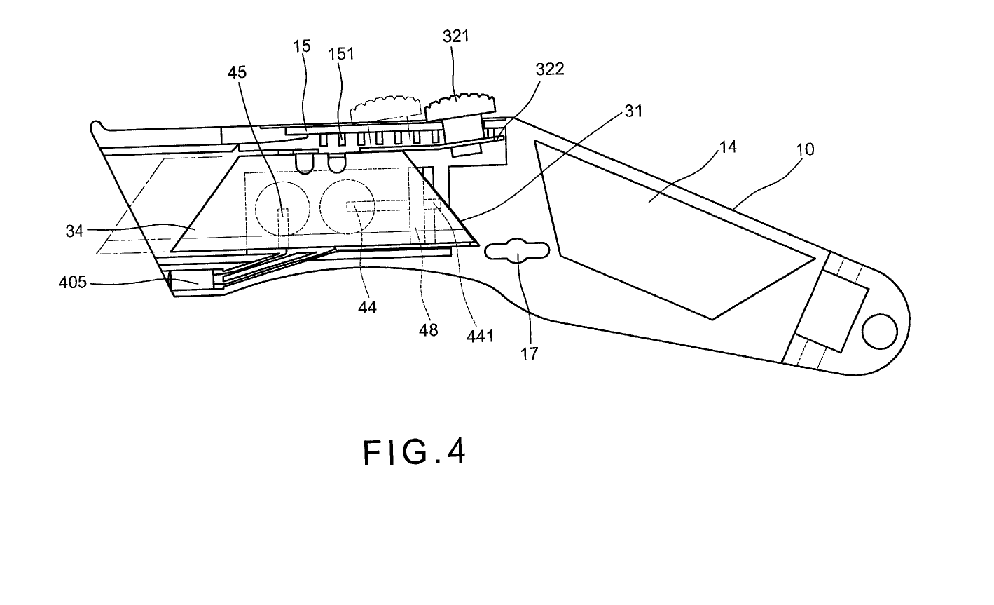

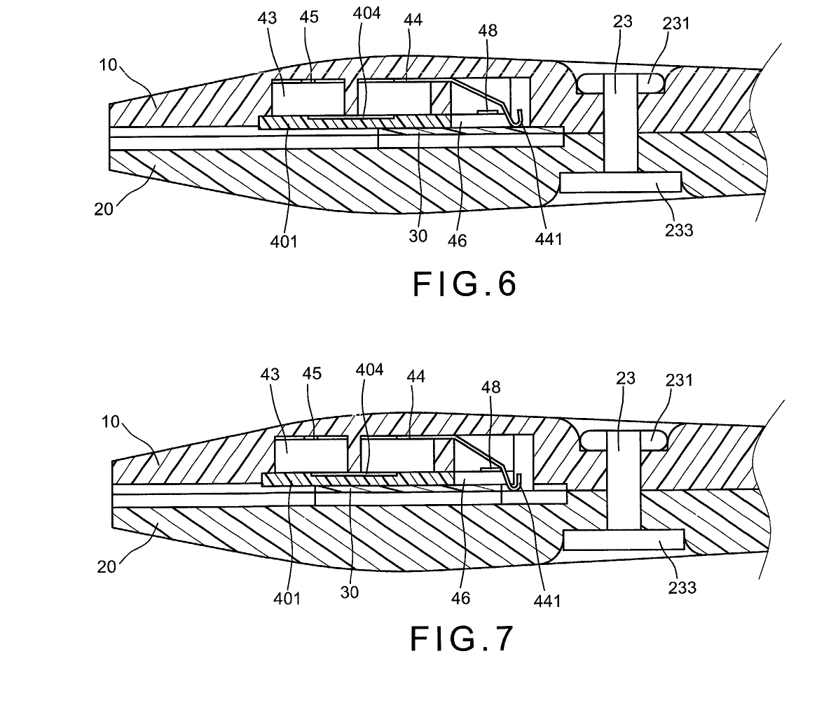

Referring FIG. 4, when the blade assembly 30 remains at its original position, the elastic plate 441 is pressed inward by the blade rack 31 so that the cathode plate 44 disengages with the L-shaped conductible plate 48 therefore the lamp 405 is not emitted (as shown in FIG. 6) due to the short circuit. When presses the thumbpiece 321 downward, the projection 322 disengages the positioning projections 151 so as to permit the blade rack 31 to move forward and disengages with the elastic plate 441 which jumps up to permit the cathode plate 44 to engage with the conductible plate 48 in order to form a current circulation that the lamp 405 is emitted (as shown in FIGS. 5 and 7).

Accordingly, the lamp 405 is operated by the blade assembly 30 without any other switch. Besides, the two halve can be made of any rigid material and is readily to disassembly without any tool.

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A heavy duty artistic knife combined with a lamp comprising:
a housing combined with a first half and a second half hinged together at their rear ends by an axial pin;
said first half having a lug at rear end including an upper ear and a lower ear each having an axial hole and a round surface, a blade chamber in an inner wall adjacent the lug for receiving spare blades, a first rectangular groove in a top thereof adjacent blade chamber including a plurality of positioning projections spaced projected downward from under side, a battery chamber formed in an inner wall under the positioning projections, said battery chamber having a pair of first and second circular grooves for respectively receiving a first and second circular batteries, a plurality of retaining holes spacedly formed in bottom of the battery chamber, a horizontal slot for receiving a bent conductible plat which has an inner end extending into bottom of the second circular groove and an outer end has a raising elastic plate, a vertical groove crassified with the horizontal slot for receiving a L-shaped conductible plate engageable with the bent conductible plate, a V-shaped disposed in bottom of the first circular groove, a circular chamber in a lower portion of front end thereof communicating with two elongate grooves for respectively receiving a lamp and two lead-in wires one of which connects to the V-shaped conductible plate and the other connects to the L-shaped conductible plate, a lid covering the battery chamber having a plurality of protrudent rods spacedly formed on inner side engageable with the retaining holes of the battery chamber, a rectangular conductible plat disposed to the inner side for connecting the two batteries and a transverse slot in one end thereof for permitting the raising elastic plate passing through to expose to outside of the battery chamber, and a first horizontal locking hole in a medial portion between the blade chamber and the battery chamber;
said second half having a second horizontal locking hole engageable with the first horizontal locking hole of the first half, a circular groove surrounding the second horizontal locking hole, a second rectangular groove in a top engageable with the first rectangular groove, a barrel projected outward from rear end engaged into the lug of the first half having an axial hole engageable with the axial holes of the lug so as to be rolatably retained by the axial pin and a pair of flat surfaces aside the barrel;
a lock locking the first and second halves together, said lock having latch inserted through the second and first horizontal locking hole of the first and second halves and a swivel button engaged into the circular groove of the second half for rotating the latch for about 90 degrees in order to look up the first and second halves;
a blade assembly slidably disposed into the first and second rectangular grooves of the first and second halves having a blade rack which is composed of a flat plate, a an extension extending outward from a top of the flat plate having a lateral projection at free end, a thumbpiece disposed on an outer end of the extension, a small pate projected laterally from the top of the flat plate, a flange projected laterally from lower edge of the flat plate and a blade disposed in the flat plate between extension and the flange having a slot on a top engaged with the small plate;
whereby, press the thumbpiece downward to slide the blade assembly forward permitting the elastic plate jumps out of the battery chamber to form a circulation of electric current to emit the lamp.

2. The heavy duty artistic knife as recited in claim 1 wherein said battery may be mercury battery and/or lithium battery.

3. The heavy duty artistic knife as recited in claim 2 wherein said batteries are disposed in the circular groove upside down with each other.

4. The heavy duty artistic knife as recited in claim 1 wherein said second half may open for about 90 degrees relative to the first half.

5. The heavy duty artistic knife as recited in claim 1 wherein said lateral projection of said black rack is engageable into each of the adjacent positioning projections of the first rectangular groove.
